(19) United States
(12) Patent Application Publication
(10) Pub. No.: US 2002/0040270 A1
(43) Pub. Date: Apr. 4, 2002

(54) Method and apparatus for vehicle navigation service using DSRC system

(76) Inventors: Dong Hoon Kwak, Seoul (KR); Yoon Suk Oh, Seoul (KR)

Correspondence Address: MERCHANT & GOULD PC, P.O. BOX 2903, MINNEAPOLIS, MN, 55402-0903, US

(21) Appl. No.: 09/736,077

(22) Filed: Dec. 13, 2000

(30) Foreign Application Priority Data
Sep. 16, 2000 (KR) 2000-54379

(51) Int. Cl. G01C 21/26

(52) U.S. Cl. 701/200; 701/210

(57) ABSTRACT

The present invention relates to an apparatus and method for a vehicle navigation service using a DSRC(Dedicate Short Range Communication) capable of providing a traffic information to which a current traffic state is adapted to a vehicle driver, so that the vehicle driver is notified of an optimum way, not a traffic congestion way, among the ways formed from the current location to a destination. Therefore, it is possible to prevent a traffic load of the traffic congestion region by avoiding the traffic congestion regions and distribute the traffic loads of the vehicles.

### BACKGROUND OF THE INVENTION

1. Field of the Invention

The present invention relates to a method and apparatus for a vehicle navigation service using a DSRC(Dedicate Short Range Communication) system, and in particular to an improved method and apparatus for a vehicle navigation service using a DSRC system which provide a vehicle driver with a traffic information and a current location of the driver in real time and a vehicle navigation service based on the current traffic state.

2. Description of the Background Art

As industry and economy are advanced and the supply of vehicles is rapidly increased, a traffic jam, car accidents and air pollution and so forth are accordingly increased, which are considered serious social problems now. In addition, economic loss due to the heavy traffic gets rather severe day by day.

Therefore, for the purpose of improving traffic environment, high technology systems using advanced information technology or communication technology have been developed.

FIG. 1 is a view illustrating a conventional vehicle navigation service apparatus, which includes a GPS(Global Positioning System) 20 for receiving a location information via satellite, a CD(Compact Disc) player 40 including a map data, a control apparatus 30 for indicating a location information received using the GPS 20 in a map data, and a display unit 10 for displaying the map data and location information.

As shown in FIG. 1, the vehicle navigation service apparatus indicates the current location of a vehicle using a simply stored map data. In this case, a road guide and the current location of a vehicle only, without actual traffic information at that time, are given. Namely, it is impossible to know the direction that a vehicle driver needs to follow to get to the destination, and the current traffic situation.

In addition, in the case that there are many vehicles on the road, it is impossible to receive any information to make the detour. In such case, an expensive GPS becomes necessary.

### SUMMARY OF THE INVENTION

Accordingly, it is an object of the present invention to provide a method and apparatus for a vehicle navigation service using a DSRC system, which provides a traffic information with respect to a moving direction of a vehicle, displaying the current location of the vehicle and traffic information on a terminal apparatus together with a map information, and provides a detour information with respect to a destination.

It is another object of the present invention to provide a method and apparatus for a vehicle navigation service using a DSRC which provides a real time traffic information service to a vehicle driver at a low cost by providing a traffic information to which the current traffic state is adapted using a DSRC system.

To achieve the above objects, there is provided a vehicle navigation service apparatus using a DSRC(Dedicate Short Range Communication) system which includes a traffic information service unit for generating traffic information in real time, a road side unit for gathering a vehicle information and a road side information needed for generating a traffic information, a remote access controller for receiving a traffic information from the traffic information service unit, transferring the received information to the road side unit, receiving a vehicle information and road side information from the road side unit and transferring to the traffic information service unit, and a terminal unit for generating a vehicle information and displaying the traffic information and a location information of the road side unit.

To achieve the above objects, there is provided a vehicle navigation service method using a DSRC(Dedicate Short Range Communication) apparatus which includes a traffic information displaying step including a first sub-step in which a traffic information service unit transfers a traffic information to a road side unit through a remote access controller, a second sub-step in which the road side unit which received the traffic information from the traffic information service unit by the remote access controller transfers a traffic information and a location information to a terminal unit having an on-board equipment, and a third sub-step in which the terminal unit which received the traffic information and location information from the traffic information service unit by the road side unit displays the traffic information and location information, and a traffic information generating step which includes a fourth sub-step in which the terminal unit transfers a vehicle information to the road side unit, a fifth sub-step in which the road side unit which received the vehicle information transfers a road side information needed for generating the traffic information to the traffic information service unit through the remote access controller, and a sixth step in which the traffic information service unit which received the vehicle information and the road side information gathers a vehicle information and road side information and generates a new traffic information.

### BRIEF DESCRIPTION OF THE DRAWINGS

The present invention will become better understood with reference to the accompanying drawings which are given only by way of illustration and thus are not limitative of the present invention, wherein;

FIG. 1 is a schematic block diagram illustrating a conventional vehicle navigation service apparatus;

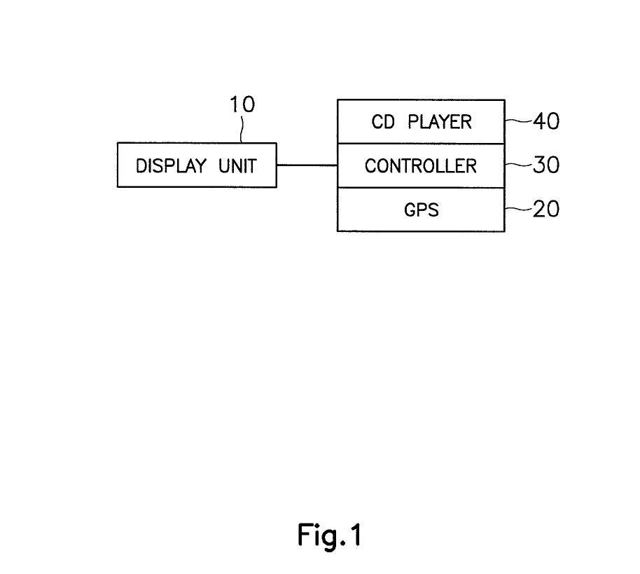

FIG. 2 is a view illustrating a vehicle navigation service system using a DSRC system according to the present invention;

FIG. 3 is a block diagram illustrating a DSRC system of FIG. 2 according to the present invention;

FIG. 4 is a view illustrating a terminal apparatus of FIG. 2 according to the present invention; and

FIG. 5 is a view illustrating an embodiment of a vehicle navigation service using a vehicle navigation service apparatus of FIG. 2 according to the present invention.

### DETAILED DESCRIPTION OF THE PREFERRED EMBODIMENTS

The embodiments of the present invention will be explained with reference to the accompanying drawings.

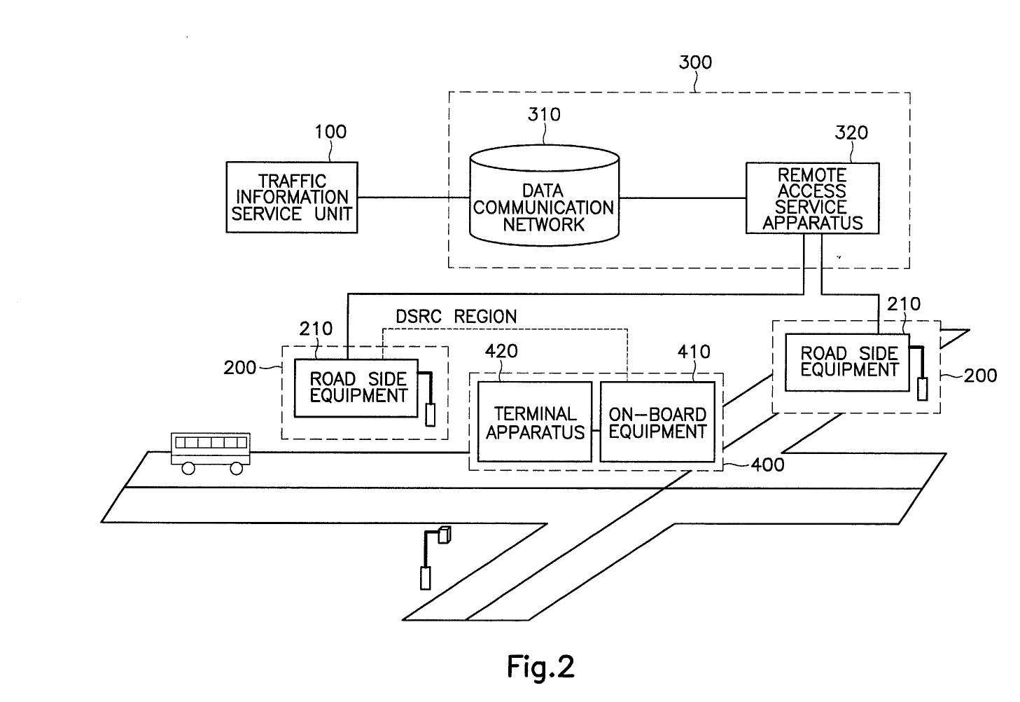

FIG. 2 is a view illustrating the construction of a vehicle navigation service providing system using a DSRC which includes a traffic information service unit 100 for generating a traffic information needed to a vehicle driver, a road side unit 200 including a road side equipment(RSE) 210 installed at a cross and a road side for generating a road side information needed for generating a traffic information, a remote access controller 300 for connecting the traffic information service unit 100 and the road side unit 200 and transferring a certain data, and a terminal unit 400 mounted in a vehicle for generating a vehicle information such as a vehicle identifier and displaying the traffic information and location information transferred from the traffic information service unit 100.

The remote access controller 300 includes a communication network(for example, a PSTN, ISDN, internet, etc.) connected with the traffic information service unit 100 for transferring a data, and a remote access apparatus(for example, a remote access server(RAS)) 320 connected with the data communication network 310 and the road side unit 200 for transmitting and receiving a data.

The terminal unit 400 includes an on-board equipment(OBE) 410 for generating a vehicle information needed for generating a traffic information, transferring the generated information to the road side unit 200 and receiving a traffic information and location information from the road side unit 200, and a terminal apparatus 420 for displaying a traffic information and location information transferred from the on-board equipment 410 using a built-in map data.

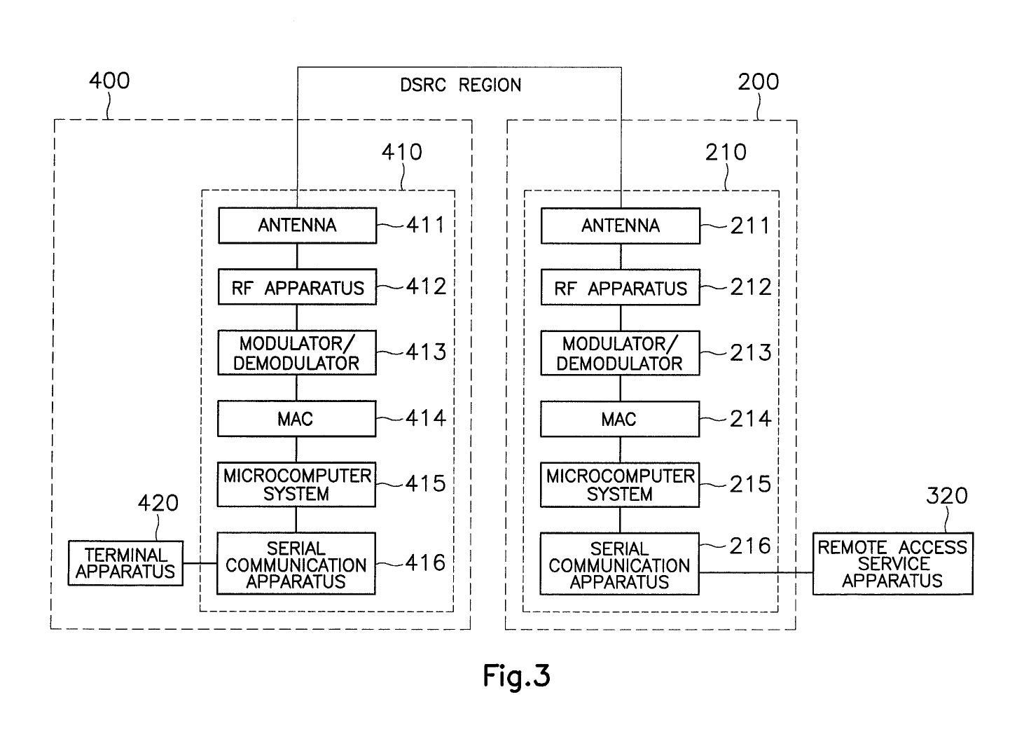

FIG. 3 is a view illustrating the construction of the DSRC system of FIG. 2 which includes the road side equipment(RSE) 210 and the on-board equipment 410 for thereby forming a DSRC region.

The road side equipment 210 and the on-board equipment 410 have a similar structure and include antenna 211 and 411 for transmitting and receiving a data signal, RF(Radio Frequency) apparatuses 212 and 412 for transmitting and receiving a signal from the antenna 211 and 411, modulator and demodulator 213 and 413 for receiving a data signal from the RF apparatus and modulating and demodulating the received data signal, a MAC(Media Access Control) 214 and 414 of a data link hierarchy, microcomputer systems 215 and 415 for performing a control function such as a data storing operation, and serial communication apparatuses 216 and 416 for performing a data transmission and receiving operation.

The road side equipment 210 and the on-board equipment 410 have a master-slave relationship. When a vehicle having the on-board equipment 410 passes through the DSRC region, the road side unit 210 reads and writes a data from/into a memory of the on-board equipment 410 for thereby implementing a communication.

Namely, the road side unit 210 reads a vehicle information such as a vehicle identifier(OBE identifier: OBE ID) from the on-board equipment 410 and writes the traffic information and location information into a memory region of the on-board equipment 410.

The road side equipment 210 which reads the vehicle information transfers a road side information such as an information concerning a time at the moment when the vehicle information is transmitted, a road side equipment identifier(RSE ID) and the vehicle information to the remote access server 320, and the remote service server 320 transfers the information to the traffic information service unit 100 through the data communication network.

The traffic information service unit 100 gathers a road side information and vehicle information transferred from the road side unit 210 and generates a traffic information. The thusly generated traffic information corresponds to a data concerning an average vehicle speed with respect to the road side unit 210, a traffic information in a certain section on a traffic congestion and traffic state, and an emergency state(for example, a traffic accident, demonstration, etc.)

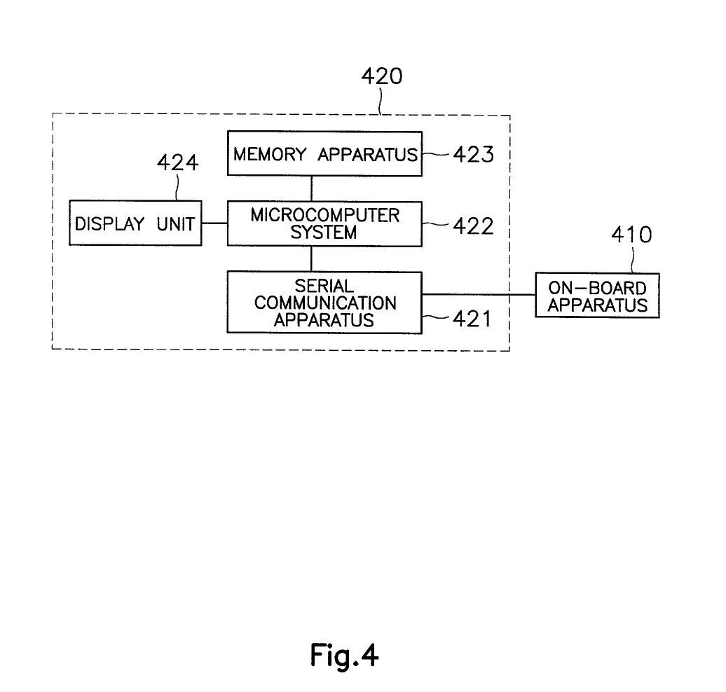

The traffic information is transferred to the road side unit 210 through the remote access controller 300. The road side unit 210 checks a vehicle identifier when a certain vehicle enters into a DSRC region and transfers a location information such as a coordinate value of the road side unit 210 and a traffic information to the on-board equipment 410 through the DSRC region. FIG. 4 is a view illustrating the construction of the terminal apparatus of FIG. 2. As shown therein, the current traffic information needed by the vehicle driver is displayed in real time, so that the vehicle driver selects an optimum way to the destination.

As shown in FIG. 4, there are provided a serial communication apparatus 421 for receiving a traffic information and location information from the on-board equipment, a memory(or a CD, flash memory, etc) 423 for storing a map data, a microcomputer system 422 for indicating the location information and traffic information transferred from the serial communication apparatus 421 on the map data, and a display unit 424 for displaying the location information and traffic information.

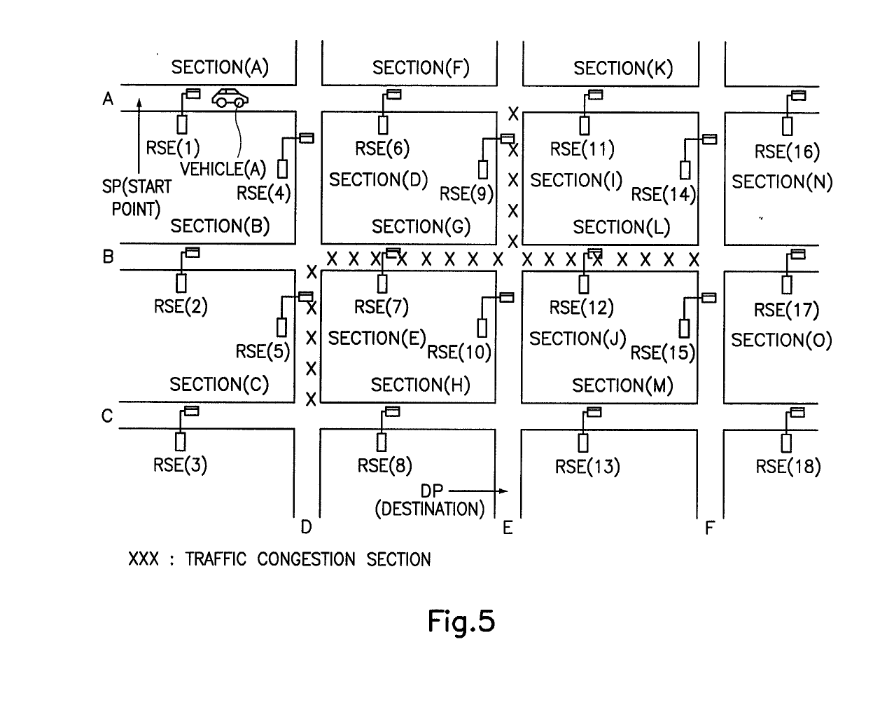

FIG. 5 is a view illustrating an embodiment of a vehicle navigation service using the vehicle navigation service apparatus of FIG. 2. As shown therein, an optimum way selected among the ways through which a vehicle A runs from a start point SP to a destination point DP based on the current traffic information is provided.

As shown in FIG. 5, the road side equipments 1 through 18 are installed in the sections A trough O of the roads A through F.

The power of the on-board equipment 410 and the terminal apparatus 420 are turned on, and the start point SP and the destination point DP are set in the terminal apparatus. Thereafter, the vehicle A runs.

When the vehicle A starts from the start point SP and passes the RSE1 and 210 through the section A of the road A, the RSE 1 transfers the traffic information received from the traffic information service unit 100 and the location information(for example, a coordinate value, etc.) of the RSE 1 to the on-board equipment 410 of the vehicle A.

The on-board equipment of the vehicle A transfers the received traffic information and location information to the terminal apparatus 410, and the terminal apparatus 410 indicates the traffic information and location information in the map data stored in the memory apparatus 423 and displays on the display unit 424.

At this time, the traffic information corresponds to the traffic state in the sections A through O, and the traffic congestion sections correspond to the sections E, G, I and L.

The way through the sections A, D, E and H and the way through the sections A, F, I and J correspond to the traffic congestion region. The way through the sections A, F, K, N, O and M which is an optimum way from the start point SP to the destination point DP is provided to the driver of the vehicle A.

The on-board equipment 410 of the vehicle A which received the traffic information transfers the vehicle information of the vehicle A to the RSE 1.

The RSE 1 transfers a road side information such as a time at the moment when each vehicle passes through the RSE 1 and a road side information such as an identifier of the RSE 1 and a vehicle information with respect to the vehicle which passes through the RSE 1 to the traffic information service unit 100 through the remote access controller 300.

The traffic information service unit 100 receives an information of the vehicles which run on each road from the RSE 1 through 18 for thereby generating a traffic information of each section, and a newly generated traffic information is transferred to the RSE 1 through 18 through the remote access controller 300.

Each RSE 410 provides a newly updated traffic information to the vehicle drivers which pass through each section, so that the traffic information is transmitted to the on-board equipment 410 installed in the vehicle and is provided to the driver through the terminal apparatus 420.

Therefore, the vehicle driver receives a real time traffic information to which an actual traffic state is adapted without using an additional vehicle navigation service apparatus.

As described above, a vehicle driver receives a real time traffic information and a current location information to which the current traffic state is adapted in real time using a DSRC system, so that the vehicle driver can get to a desired destination through an optimum way among the ways from the current location to the destination without passing through a complicated way.

In addition, since the vehicle driver generally avoids the traffic congestion regions, it is possible to prevent a traffic congestion region and distribute the traffic load of the vehicles. In addition, it is possible to receive a vehicle navigation service at a low cost without using an expensive GPS.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### What is claimed is:

1. In a vehicle navigation service apparatus using a DSRC(Dedicate Short Range Communication) system, a vehicle navigation service apparatus using a DSRC, comprising:
a traffic information service unit for generating a traffic information in real time;
a road side unit for gathering a vehicle information and a road side information needed for generating traffic information;
a remote access controller for receiving a traffic information from the traffic information service unit, transferring the received information to the road side unit, receiving a vehicle information and road side information from the road side unit and transferring to the traffic information service unit; and
a terminal unit for generating a vehicle information and displaying the traffic information and a location information of the road side unit.

2. The apparatus of claim 1, wherein said road side unit includes a road side equipment(RSE).

3. The apparatus of claim 1, wherein said remote access controller includes:
a data communication network for receiving and outputting a traffic information from the traffic information service unit and transferring the vehicle information and the road side information to the traffic information service unit; and
a remote access means for receiving a traffic information from the data communication network, transferring the received information to the road side unit, receiving a vehicle information and road side information from the road side unit and transferring the received information to the data communication network.

4. The apparatus of claim 1, wherein said terminal unit includes:
an on-board means for forming a DSRC(Dedicate Short Range Communication) region and generating a vehicle information; and
a terminal apparatus for generating a map data, displaying the current location and the traffic information and performing a way guide function.

5. The apparatus of claim 4, wherein said on-board means is an on-board equipment(OBE).

6. In a vehicle navigation service method using a DSRC(Dedicate Short Range Communication) apparatus, a vehicle navigation service method using a DSRC apparatus, comprising:
a first step having:
a first sub-step for transferring a traffic information generated by a traffic information service unit to a road side unit through a remote access controller;
a second sub-step in which the road side unit which received the traffic information from the traffic information service unit transfers a traffic information and a location information to a terminal unit having an on-board means; and
a third sub-step for displaying the current location and an optimum way of a vehicle in the terminal unit which receives the traffic information and location information by the road side unit; and
a second step having:
a fourth sub-step in which the terminal unit transfers a vehicle information to the road side unit;
a fifth sub-step in which the road side unit which received the vehicle information transfers a road side information needed for generating the traffic information to the traffic information service unit through the remote access controller; and
a sixth step in which the traffic information service unit which received the vehicle information and the road side information gathers a vehicle information and road side information and generates a new traffic information.

7. The method of claim 6, wherein in said sixth sub-step of the second step, a real time traffic information is generated using a road side information transferred from the road side unit when the traffic information is generated.
